(19) United States
(12) Patent Application Publication
(10) Pub. No.: US 2009/0286219 A1
(43) Pub. Date: Nov. 19, 2009

(54) CONDUCTING A VIRTUAL INTERVIEW IN THE CONTEXT OF A LEGAL MATTER

(76) Inventors: Roman KISIN, San Jose, CA (US); Deidre Paknad, Palo Alto, CA (US); Pierre Raynaud-Richard, Redwood City, CA (US)

Correspondence Address: GLENN PATENT GROUP, 3475 EDISON WAY, SUITE L, MENLO PARK, CA, 94025, US

(21) Appl. No.: 12/121,758

(22) Filed: May 15, 2008

(51) Int. Cl. G09B 7/00

(52) U.S. Cl. 434/362

(57) ABSTRACT

A virtual interview is conducted in the context of a legal matter, for example, using online forms, thus enabling rapid and large-scale information capture from distributed recipients. A user can define questions and virtual interviews once, and use them again and again; can define an approved set of questions to insure consistency of interview practice; and can de facto improve the consistency and credibility of information gathering in legal matters. Users can pre-establish action items that are automatically created upon receiving specific responses to virtual interviews. Interview response may be managed by exception, i.e. exception alerting, and tools are provided to view exceptional cases for follow-up action. For example, alerts can be issued on the basis of such factors as: if any one responded that they had data at home, send an alert to the attorney and an action item to do an appropriate collection; and if anyone responds that they know others in scope, initiate an action item assigned to paralegal to add identified individuals to scope. A user can conduct many interviews systematically to determine where all key facts related to the matter are located; to update information in a highly distributed way for effective legal management; and to manage responses efficiently.

### BACKGROUND OF THE INVENTION

1. Technical Field

The invention relates to litigation. More particularly, the invention relates to software technology for creating, publishing, and executing virtual interviews during active litigation.

2. Description of the Prior Art

Companies have a clear legal duty to preserve evidence when they anticipate or have litigation, tax or regulatory inquiries. To do this, litigation personnel, among other things, must communicate with the key players in the litigation to understand where the relevant data and evidence are stored, and to identify other employees who may have information pertaining to the legal matter at hand. This information is typically discovered by interviewing the key players and other individuals involved in the legal matter. Even if they use other means to identify potentially relevant documents, companies are usually expected to interview all key players systematically as a means to cross-check the information they have, identify any potential gaps in that information, establish time lines and collect all information

In this setting, the legal team is faced with various challenges when performing face-to-face interviews including, for example, the following:
Companies face thousands of law suits, each such law suit involving hundreds and often thousands of individuals and systems;
Interviewing is a time consuming process that results in a high cost of litigation;
Interviewing is low in efficiency due to limited or no exception based processing;
Interviewing produces unstructured data that provide limited leverage of automation, if any, and that make it difficult or tedious to compile and/or assess the results of such interviews;
Interviewing has a lack of process consistency;
In an interview, there is no ready ability to compare data with that of prior and/or subsequent interviews; and
Interviewing requires manual data entry that results in:
   Increased legal liabilities;
   Low reliability due to low data accuracy; and

Use of disparate and unstructured storage solutions, e.g. scattered data captured by different staff and/or stored or captured in different formats, which can make it difficult to compare or synthesize the data received or to compare data with data obtained during previous and/or subsequent interviews.

It would be advantageous to provide the ability to perform face to face interview, while avoiding the above challenges attendant with such procedure.

### SUMMARY OF THE INVENTION

An embodiment of the invention provides a method and apparatus for conducting and processing the results of the interview process as defined in the context of a legal matter. For purposes of the discussion herein, the content defined and authored as part of this invention is referred as a “Virtual Interview” and comprises such elements as a message, introductory text, questions, closing text, and processing workflows, all of which are created for a specific purpose.

In one embodiment, it is possible to conduct virtual interviews using electronic forms, thus enabling rapid and large-scale information capture from distributed recipients. The invention allows a user to define questions and virtual interviews once, and to use them again and again; and to define an approved set of questions to insure consistency of interview practice, and de facto improve the consistency and credibility of information gathering in legal matters. The invention allows users to pre-establish action items that are automatically created upon receiving specific responses to virtual interviews. Thus, behavior of the invention for a given response can be pre-defined. In this way, the invention can, for example, sort, focus on, and/or consolidate answers according to specific responses received to questions.

The invention provides both the ability to manage interview responses by exception, i.e. exception alerting, and tools to view exceptional cases for follow-up action. For example, alerts can be issued on the basis of such factors, or for such purposes, as:
If anyone responded that they had data at home, send an alert to the attorney and an action item to do an appropriate collection;
If anyone responds that they know others in scope, initiate an action item assigned to a paralegal to add identified individuals to the scope;
To add people automatically, e.g. for purposes of an interview;
To update the attributes of another system object; and
To initiate workflows combining reviews and actions, including and not limited to all of the above.

The invention provides a non-response workflow around interviews. In particular, the invention provides the ability to send reminder notices when the person in question has not submitted an interview response, alert appropriate legal staff, escalate non-compliance to management, and any combination of the foregoing

The invention also provides improved quality of the data captured by capturing a response in a highly structured form versus simple text.

The invention also provides improved ability to analyze a large response set by storing all responses in a database and allowing mining and filtering on the data by such factors, for example, as recipient, question, answers, time, matter, and the like, and export of the data in structured form.

Further, the invention also provides the ability to repeat the execution of the interview automatically to insure that any new data are captured reliably, thus increasing the credibility of the interview process in court.

### BRIEF DESCRIPTION OF THE DRAWINGS

FIG. 1 is a block schematic diagram showing virtual interview elements according to the invention;

FIG. 2 is a block schematic diagram showing actions generated as a result of a virtual interview submission according to the invention;

FIG. 3 is an example of a UI that can be used to create a question in the virtual interview according to the invention;

FIG. 4 is an example of a UI that can be used to associate action items or alerts with a specific role such as “Attorney,” “Paralegal,” etc. according to the invention;

FIG. 5 is an example of a UI showing an example of how list of questions get edited according to the invention;

FIG. 6 is an example of a UI showing what the interviewee receives when a virtual interview is executed according to the invention; and

FIG. 7 is an example of an action item UI showing a legal matter, request, and other context information, description of the action item that contains the actual question, and answers submitted by interviewee according to the invention.

### DETAILED DESCRIPTION OF THE INVENTION

An embodiment of the invention provides a method and apparatus for conducting and processing the results of the interview process as defined in the context of a legal matter. For purposes of the discussion herein, the content defined and authored as part of this invention is referred as a “Virtual Interview”, and comprises such elements as a message, introductory text, questions, closing text, and processing workflows, all of which are created for a specific purpose.

The invention allows the targeting and segmenting of interview recipients and allows the establishment of intervals at which the interview is conducted. An aspect of the invention tracks each inbound and outbound interview in a series of related interviews, where such related interviews can be grouped into sets and sub-sets, i.e. by matter and/or requests and/or groups of recipients. Non-responses to interview requests can be automatically addressed by resending the requests, generating alerts, escalation, or combinations thereof.

The invention provides for the following capabilities:
The ability to author the Virtual Interview, including:
   Creation, reuse, and editing of an interview plan representing the business activity associated with execution of the virtual interview in the context of a particular matter/request. It is a list of recipients and a virtual interview, and comprises such information as a plan name, plan ID, status, and target completion date.
   Creation, reuse and editing of rich text sections (similar to compound documents, such as Microsoft Word), used as introductory text, detailed instructions, clarification or context explanations, closing text, etc.;
   Creation, reuse, and editing of structured questionnaires as an ordered list of questions offering a wide range of structure responses, using single choice, multiple choice, free form responses, and any combination thereafter; defining the authorized response options; defining the appearance of the question and response selection using any type of UI widgets, such as combo box, radio button, pull-down list, popup-chooser, etc.;
   Configure workflows between different questionnaires and external UI modules so recipients may only see or interact with the questionnaire relevant to them, based on answers already defined; or recipients may be asked to complete specific data review, entry, or validation based on their current answers;
   Configure workflows for reviewing, processing, and persisting results once results are received; and
   Any of the above, combined in any relevant order.

The ability to define the list of recipients to who the Virtual Interview should be sent.

Manage the delivery of the Virtual Interview, including:
Delivering the resulting interview notice to each recipient and insure that they can properly respond to applicable questions, and capture those responses;
Executing workflows defined between questionnaire and a dedicated UI module that may be used to capture review, validate, or capture more complex data defined in the context of specific answers from the recipient and/or specific attributes of the recipient known in advance by the system;
Handling non-responses through automated reminders, automated alert appropriate legal staff, escalation of non-compliance to management, and any combination of the foregoing automated escalations, or any other automated action targeted at increasing the response rate;
Automatically repeating interviews at a periodic interval, to insure that any new data are captured reliably, thus increasing the credibility of the interview process in court; and
In one embodiment, conduct virtual interviews using electronic forms, thus enabling rapid and large-scale information capture from distributed recipients.

Execute the processing workflows on the resulting answers, including:
Routing of subset of the answers to an individual or groups including author, reviewer, or another named individual or based on the role, for the purpose of reviewing, validating, or editing the specific answers, or selecting next steps in the workflow;
Publishing data to various systems, typically a database or other system that stores structured data, to which data is relevant, with the purpose to update or create appropriate business objects;
Initiating or assigning follow-up actions that may or may not be tracked as part of the same system. For example, an embodiment of the invention provides both the ability to manage interview responses by exception, i.e. exception alerting, and tools to view exceptional cases for follow-up action.

For example, alerts can be issued on the basis of such factors, and purposes, as:
If anyone responded that they had data at home, send an alert to the attorney and an action item to do an appropriate collection;
If anyone responds that they know others in scope, initiate an action item assigned to a paralegal to add identified individuals to the scope;
To add people automatically, e.g. for purposes of an interview; and
To update the attributes of another system object.

Improved ability to analyze a large response set by:
Storing all responses in a database and allowing mining and filtering on the data by such factors, for example, as recipient, question, answers, time, matter, and the like, and export of the data in structured form; and

Validate, review, search, sort, consolidate, or through any other means, analyze or extract knowledge from the result set, with the a purpose related to the legal matter being processes, prediction of patterns relevant to future legal matter, or other analytical purposes related to the function of the organization using the Virtual Interview application.

Enable a high level of control and reuse, including:
The ability to reuse all or parts of previously created virtual interview;
Define privileges and authorization for all users involved in creation or reuse of parts or all of previously created Virtual Interviews or templates;
Allows a user to define questions and virtual interviews once, and to use them again and again; and to define an approved set of questions to insure consistency of interview practice, and de facto improve the consistency and credibility of information gathering in legal matters.

To establish efficient and repeatable processes for identifying the scope of a legal matter or gathering other types of information from a wide audience, a new mechanism referred to as a virtual interview process is taught herein. In one embodiment, the virtual interview comprises a set of tools that can efficiently support the following operations:
Define a question, its possible answers or options for response, and its presentation, with a variety of question types, such as a drop-down list, text boxes, yes/no, etc;
Compose multi-question questionnaires using lists of questions;
Define workflow linking these questionnaires together;
Compose supporting rich text sections to integrate the questionnaires and workflows into a virtual interview;
Make virtual interview or any of its individual part available for reuse in the future;
Reuse all or parts of previously created virtual interviews;
Create a new question;
Associate processing workflows with particular answers, set of answers or any combination of result set;
Identify a set of individuals targeted by the virtual interview;
Publish virtual interview to a set of individuals, e.g. via email;
Deliver the virtual interview electronically to enable efficient scaling;
Allow the recipient to complete the virtual interview and its related internal workflow, and capture all answers;
Integrate with an external UI module as triggered by applicable workflows to complete specific complex steps related to external data, as part of the overall virtual interview workflows; and capture all resulting data from that interaction;
Processing workflows triggered by the result set, including:
   Review, validation or editing by relevant individual; and
   Data created or update in relevant system; and
Data mining to view, browse, search, and report responses based on the answer to specific questions, triggered workflows, issuance, etc.

With the inventive technique, companies can follow a thorough and well documented process to gather information from key players to define the scope and identify people and data involved, that enable them to face any challenges from the court or their opponent in confidence. This more reliable and transparent process also dramatically increases the efficiency and scalability, while reducing costs through, for example, the following:
Conducting online interviews using electronic forms, enabling rapid and large-scale knowledge capture from a distributed audience;
Improved non-response workflow around interviews. In particular, the ability to send reminder notices when the person in question has not submitted an interview response;
Provides the ability to manage interview responses by exception, e.g. exception alerting, and provides tools to view exceptional cases for follow-up action; and
Provides the ability to document all of the steps of the process in detail and to defend it in court if challenged.

### Virtual Interview Extensions or Mini-Applications

In certain cases, capturing the information provided by the interviewee requires more than a one way exchange between the interviewee and the system driving the interview process. This includes cases, such as:
The interviewee needs to select an element from a list of possible options, but does not know a unique identifier for that element. In such case, iteration between the interviewee and the system is required to refine the selection until the correct element is identified. This is, for example, needed to identify the correct “Bob Smith” within a large company where there might be many of Bob Smith's. In that case, the interviewee is able to enter “Bob Smith”, and the system provides a list of possible match with additional information, such as the organization they belong to, location, title, etc., allowing the interviewee to then select the correct “Bob Smith.”
The interviewee is expected to enter precise data that is compliant with certain validation rules. For example, the interviewee may be asked to enter detailed information about a newly installed system. Such information should not be entered into a system catalog until it has been validated to comply with the data schema and constraints required of such information. This can be performed interactively during the data entry process if the system has the ability to iterate with the interviewee by providing feedback on the initial entry, accepting a new version, and iterate again.
The interviewee is expected to review and edit existing data that the system already knows about. This case is a combination and extension of the two cases set forth immediately above, in the sense that the interviewee may first need to identify uniquely a known object, then receive the details of the known data, and then iterate on modifying this data as needed, while remaining compliant with existing constraints on the data model used to represent that data.

An extension mechanism for virtual interview provides the ability to create a fully interactive UI (typically list, search screen, review or edit forms, or a combination of any of them) and integrate them in the workflow of a virtual interview. These extensions are essentially small, self-contained web applications with specific set of entry parameters, and variable set of output parameters, that may include initiating a transaction in an existing database, and a specific internal workflow.

As part of the main virtual interview workflow, a condition can be set to test for certain responses or a pattern of responses on the answers of the interviewee, which then triggers a specific mini-application to be invoked with specific parameters configured by either the original users who created the virtual interviews, or certain of the answers already entered by the interviewee. The interviewee is then given the opportunity to interact with the mini-application to complete a more complex data entry task, as described above. Once completed, the interviewee is returned to the next regular step in the main virtual interview workflow. Potentially multiple different mini-applications could be invoked during an interview, some of them potentially multiple times.

As described in the example above, a typical example of a mini-application is a person picker which, given partial information to identify a person, allows the interviewee to iterate to select the right person. The ability to trigger such person chooser conditionally from a condition set within the interview questionnaire, and integrate back the selected information in the interview result set makes the mini-application extension of the virtual interview an extremely valuable tool to enhance further the quality and quantity of information that can be captured. Another common case of a very useful mini-application resides in a data entry and editing form for business objects of which this interviewee may have a detailed knowledge. For example, the ability to ask the interviewee if he knows of a newly added storage system that he has not yet registered in the system catalog, and if he says “yes”, immediately offering the opportunity to enter and validate details for that system, and tie it to the original interview greatly increases overall process efficiency and productivity.

### Data Model

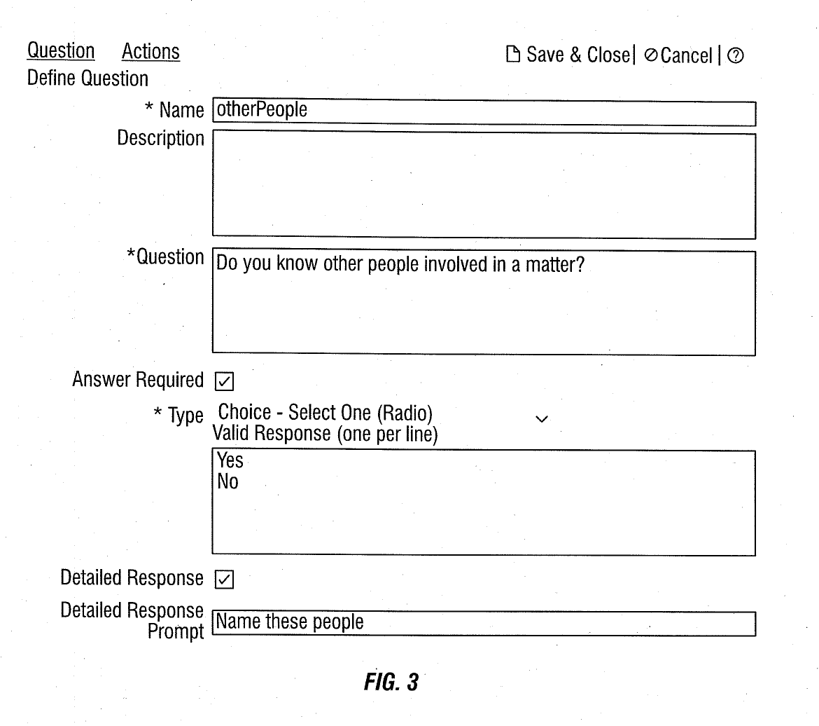

To support the technique herein disclosed, a data model that represents matters, requests, and virtual interview elements is required. FIG. 3 is a block schematic diagram showing virtual interview elements according to the invention, and which defines the following:
A matter is a legal matter 10, e.g. a civil or regulatory matter. A matter contains one or more requests, and comprises such information as a matter name and matter ID.
A request 11 defines the scope of the potentially relevant information and/or knowledge to be preserved and potentially produced. A request comprises such information as a request name, request ID, and status.
An interview plan 13 is an element representing the business activity associated with execution of the virtual interview in the context of a particular matter/request. It is a list of recipients and a virtual interview, and comprises such information as a plan name, plan ID, status and target completion date.
A virtual interview 15 is a list of questions, including information about how to present the questions, per-question attributes, e.g. required/optional question, associated workflows, and other meta-data. The virtual interview comprises such information as a virtual interview name, ID, and status.
A virtual interview response 17 is a response to a virtual interview, a set of responses to questions in the virtual interview including the triggered actions. The virtual interview response includes such information as an issuance, a response value, and triggered actions.
A recipient 12 is a person who has created a response, which may be different from the person who submits the response into the system, i.e. the submitter.

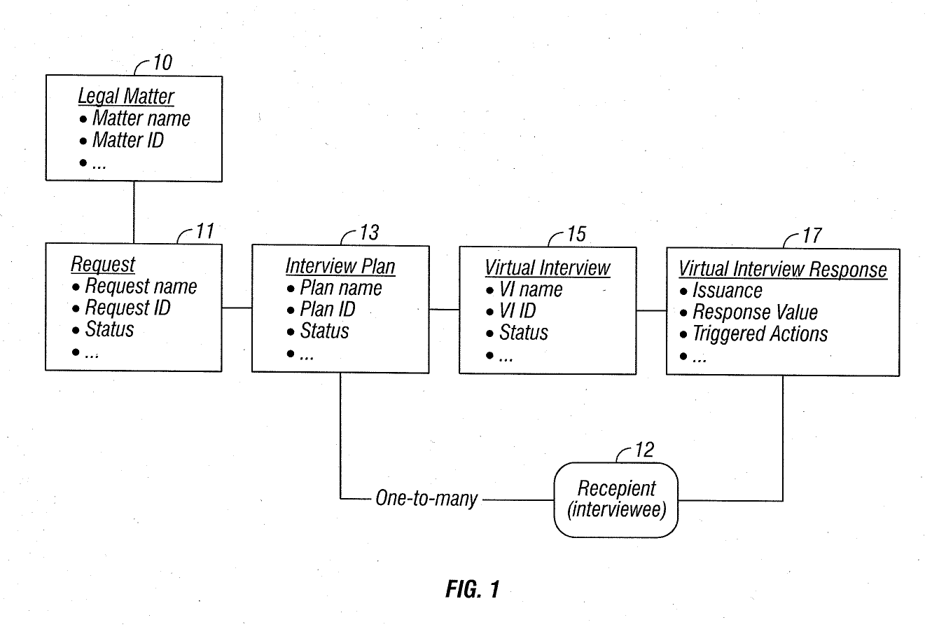

Relationships between the virtual interview response and associated actions are defined by the data model shown in FIG. 1.

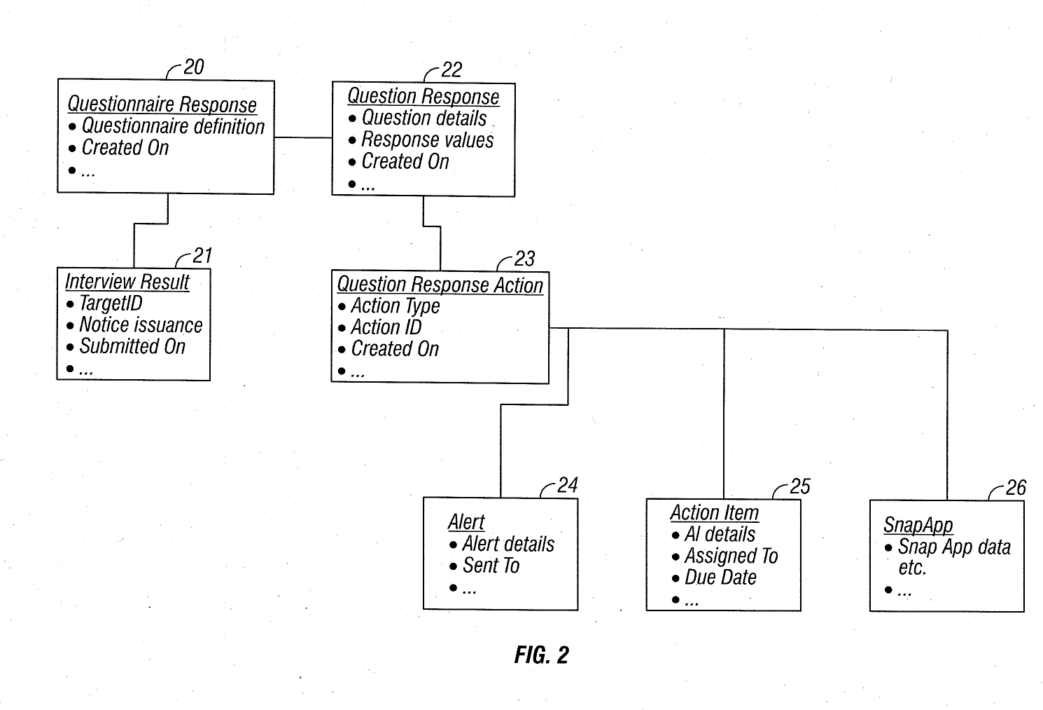

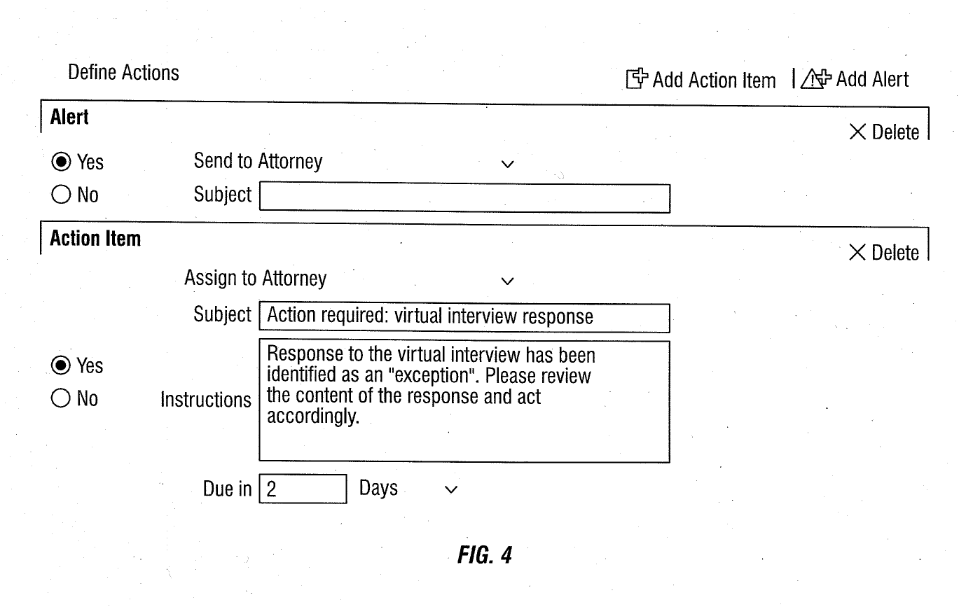

FIG. 4 is a block schematic diagram showing actions generated as a result of a virtual interview submission according to the invention. In FIG. 2, an interview result 21, comprising such information as a target ID, notice issuance, and submitted on date, is generated from a questionnaire response 20, which can comprise a questionnaire definition, created on date, and the like. A question response 22 is also provided, which can comprise question details, response values, and created on date information.

A question response action 23 is generated which can comprise such information as an action type, action ID, and a created on date. As noted earlier responses to virtual interview can be managed by exception. The following types of exception workflow processing or actions are supported:
An alert 24, which is a simple notification sent to an individual in the context of a legal matter;
Action items 25, which contain the date when the action item is created and when the action is due, the name of the person to whom the action is assigned, a short description of the action, and instructions; and
A set of mini-applications 16 that is pushed to users, based upon the virtual interview responses and other events, to facilitate the data entry and validation tasks. Mini-applications are discussed in greater detail above. Below are some examples of mini-applications:
   A matter scoping mini-application to validate names of the affected people and systems and streamline the data entry tasks;
   A mini-application that provided interactive data entry to ensure that precise data is entered that is compliant with certain validation rules;
   A data source information maintenance mini-application to push the data source information entry to users; and
   A mini-application that encapsulates certain data fields for presentation and completion by a user in the context of an interview

### Creating Virtual Interviews

The legal organization strategy should include a requirement for creating repeatable and defensible process for virtual interviews. This includes the ability to control permissions to ensure that only authorized users are able to create virtual interviews, and the ability to re-use previously created virtual interviews in the context of future legal matters.

FIG. 3 is an example of a UI that can be used to create a question in the virtual interview according to the invention. The UI also allows the attorney to associate alerts, action items, and other actions/workflows with specific answers to specific questions. The attorney creating the virtual interview can define how the workload of processing the results is distributed among the members of a legal staff, based on generic classification of people, based on role. This includes the ability to associate action items or alerts with a specific role such as “Attorney” (means Attorney in charge of the specific matter), “Paralegal” etc. FIG. 4 is an example of a UI that can be used to associate action items or alerts with a specific role such as “Attorney,” “Paralegal,” etc. according to the invention.

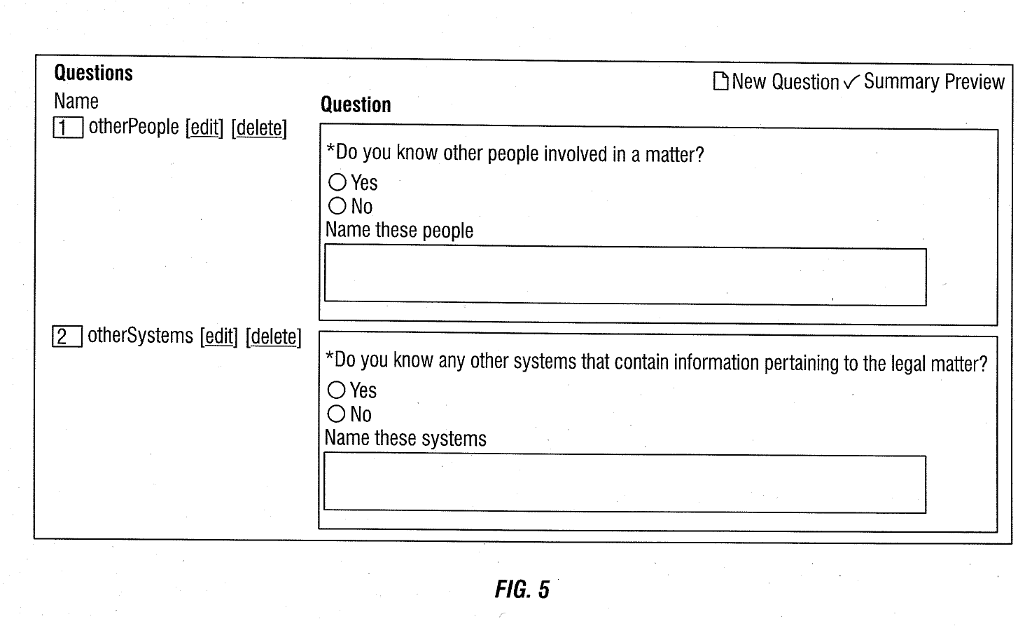

FIG. 5 is an example of a UI showing an example of on-the-fly editing and structured editing according to the invention.

In addition to creating new questions, the attorney can re-use previously created questions and virtual interviews. The attorney can reuse all or parts of single set of questions or full list of questions, and customize them to specific needs.

### Execution of Virtual Interview

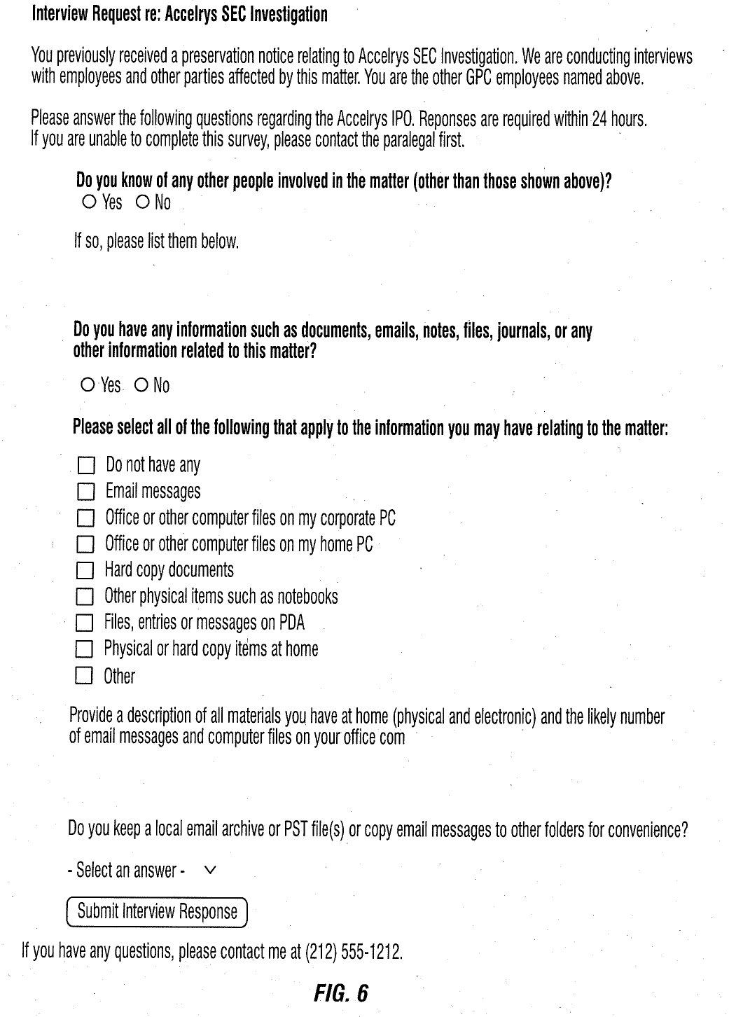

At the time a virtual interview is published, the interviewees receive a notification about the virtual interview. The process of viewing and submitting the virtual interview responses is also known as the execution of the virtual interview. FIG. 6 is an example of a UI showing what the interviewee receives when a virtual interview is executed according to the invention

### Generating a List of Exceptional Responses

From the above data structures, in particular the actions generated as a result of the virtual interview submission, a list of all exceptional responses can be generated. These data are key to drive significant increase in the efficiency and reliability of data processing collected from a wide audience, including creating scope of a legal matter, monitoring ongoing compliance, etc.

Examples are listed below in Tables 1 and 2 that show interview results by interviewee. Answers that appear in bold ate those which were determined to be exceptions that require appropriate handling by the legal team.

TABLE 1
ABRONY, ARMAN

| | | ADDITIONAL |
|---|---|---|
| | | INFORMATION |
| QUESTION | ANSWER | PROVIDED |
| Do you know other | Yes | Scott Perry, |
| people involved? | | Michael Zhu, |
| | | Jill Ross |
| Do you have any | Email messages, Office or | |
| information pertaining | other computer files on my | |
| to the matter? | corporate PC, Office or | |
| | other computer files on | |
| | my home PC | |
| Do you have any | I have about 10 | |
| materials pertaining to | presentations on my home | |
| the matter at home? | PC. | |
| Do you keep local copies | No | |
| of you emails? | | |

TABLE 2
ABER, HARRY

| | | ADDITIONAL |
|---|---|---|
| | | INFORMATION |
| QUESTION | ANSWER | PROVIDED |
| Do you know other | Yes | Jason Scott, |
| people involved? | | Patrick Miller |
| Do you have any | Email messages, Office or | |
| information pertaining | other computer files on my | |
| to the matter? | corporate PC, Office or other | |
| | computer files on my home | |
| | PC | |
| Do you have any | I have about 30 | |
| materials pertaining | presentations and | |
| to the matter at | proposals on my home PC. | |
| home? | | |
| Do you keep local | Yes | |
| copies of you emails? | | |

The information captured during execution of the virtual interview can be reported and filtered in a variety of ways to facilitate and accelerate analysis and processing of the responses, for example, as:
An entire set of responses;
Filtered by:
   questions;
   answers; and
   exceptions.
A single report that shows the structure of the virtual interview, including:
   Virtual interview plan details;
   Detailed information on every question in the virtual interview, including exact wording, type, and possible answers;
   List of interviewees; and
   Results ordered by questions and interviewees.
To include or not include historical information, including responses to the repeating virtual interviews. This includes the ability to focus on interview respondents who have given certain answers, e.g. “Yes, I know someone who . . . ”.

### Exception Driven Workflow Processing

When dealing with the large amounts of data collected in the scope of a legal matter it becomes critical to support exception based processing. The exception-based model enables efficient handling of workload, e.g. only follow-up on those parties who have additional information, need assistance, etc.

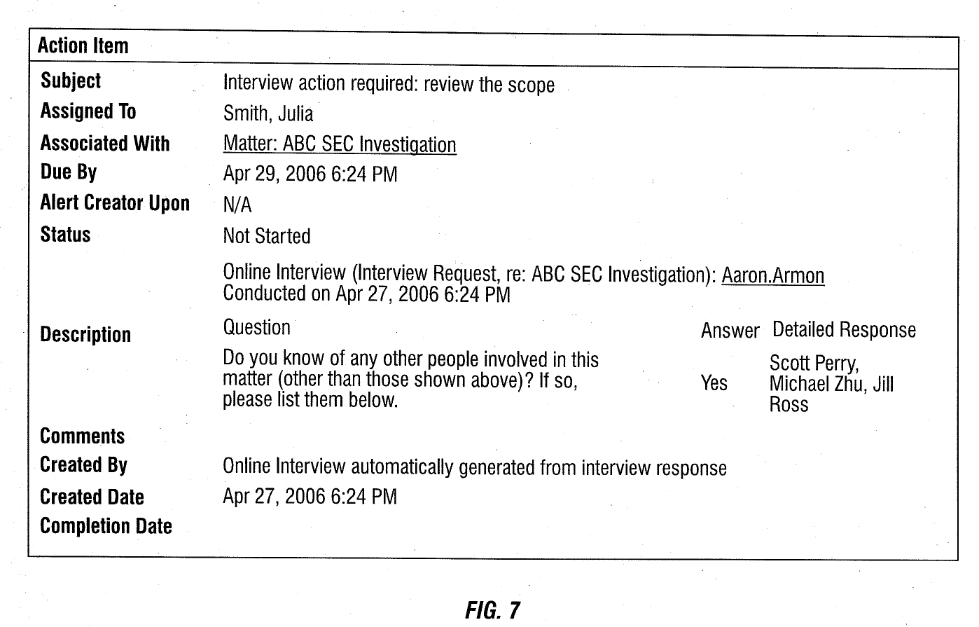

The action item UI shows a legal matter, request, and other context information; a description of the action item contains the actual question and answers submitted by interviewee; and the answer that triggered the exception processing that resulted in the creation of the action item. An action item is assigned to a person who has a role on the matter that has been specified when defining the question, see the section above, entitled Creating Virtual Interviews, for details on the action UI. FIG. 7 is an example of an action item UI showing a legal matter, request, and other context information, description of the action item that contains the actual question, and answers submitted by interviewee according to the invention.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for conducting a virtual interview in the context of a legal matter, comprising the steps of:
defining a question, possible answers or options for response to said question, and presentation of said question, with a variety of question types;
composing multi-question questionnaires using lists of questions;
defining a workflow linking said questionnaires together;
composing supporting rich text sections to integrate said questionnaires and workflows into a virtual interview; and
making a virtual interview or any of its individual parts available for reuse.

2. The method of claim 1, said presentation of question types comprising any of;
a drop-down list, text boxes, and yes/no questions.

3. The method of claim 1, further comprising the step of:
reusing all or parts of previously created virtual interviews.

4. The method of claim 1, further comprising the step of:
create a new question.

5. The method of claim 1, further comprising the step of:
associating processing workflows with particular answers, set of answers, or any combination of result sets.

6. The method of claim 1, further comprising any of the steps of:
identifying a set of individuals targeted by the virtual interview;
defining an interview plan computing defining due date and dividing targeted individuals into logical sets per functional group;
publishing a virtual interview to each set of individuals;
delivering said virtual interview electronically to enable efficient scaling;
allowing a recipient to complete said virtual interview and a related internal workflow; and
capturing all answers thereto made by said recipient.

7. The method of claim 1, further comprising the steps of:
integrating with an external UI module as triggered by applicable workflows to complete one or more specific complex steps related to external data as part of an overall virtual interview workflow; and
capturing all resulting data from said integration.

8. The method of claim 1, further comprising the steps of:
processing workflows triggered by a result set by reviewing, validating, or editing by relevant individual; and
creating or updating data as relevant.

9. The method of claim 1, further comprising the step of:
data mining to view, browse, search, and report responses based on answers to specific questions, triggered workflows, and issuance.

10. The method of claim 1, further comprising the step of:
sending reminder notices when a person in question has not submitted an interview response.

11. The method of claim 1, further comprising the step of:
repeating execution of an interview automatically at specified, user configurable intervals to insure that any new data are captured reliably.

12. An apparatus for conducting a virtual interview, comprising:
a data model that represents matters, requests, and virtual interview elements, wherein:
a matter comprises a legal matter containing one or more requests;
a request defines the scope of potentially relevant information and/or knowledge to be preserved and potentially produced;
an interview plan representing a business activity associated with execution of said virtual interview in the context of a particular matter/request;
a virtual interview comprising a list of questions, including information about how to present the questions, per-question attributes, associated workflows, and other meta-data;
a virtual interview response comprising a response to a virtual interview, a set of responses to questions in said virtual interview including triggered actions; and
a recipient comprising a person who has created a response;
an approved set of questions to insure consistency of interview practice; and
a plurality of electronic forms populated with said questions to enable rapid and large-scale information capture from a distributed audience.

13. The apparatus of claim 12, further comprising:
a set of tools for any of:
defining a question, possible answers or options for response to said question, and presentation of said question, with a variety of question types;
composing multi-question questionnaires using lists of questions;
defining workflow linking said questionnaires together;
composing supporting rich text sections to integrate said questionnaires and workflows into a virtual interview;
making virtual interview or any of its individual parts available for reuse;
reusing all or parts of previously created virtual interviews;
creating a new question;
associating processing workflows with particular answers, set of answers, or any combination of a result set;
identifying a set of individuals targeted by said virtual interview;
publishing a virtual interview to a set of individuals;
delivering a virtual interview electronically to enable efficient scaling;
allowing a recipient to complete a virtual interview and its related internal workflow, and to capture all answers;
integrating with an external UI module as triggered by applicable workflows to complete specific complex steps related to external data as part of an overall virtual interview workflows;
capturing all resulting data from said integration;
executing processing workflows triggered by a result set including:
reviewing, validating, or editing by a relevant individual; and
creating or updating data as relevant; and
performing data mining including any of viewing, browsing, searching, and reporting responses based on answers, to any of specific questions, triggered workflows, and issuance.

14. The apparatus of claim 12, said tool for presentation of question types comprising any of:
a drop-down list, text boxes, and yes/no questions.

15. The apparatus of claim 12, wherein a virtual interview is defined and then authored, and comprises any of a message, introductory text, questions, and closing text, all of which are created for a specific purpose.

16. The apparatus of claim 12, further comprising:
means for targeting and segmenting interview recipients.

17. The apparatus of claim 12, further comprising:
means for establishing intervals at which a virtual interview is conducted.

18. The apparatus of claim 12, further comprising:
means for tracking each inbound and outbound virtual interview in a series of related interviews, wherein said related interviews are grouped into sets and sub-sets by any of matter and/or requests and/or groups of recipients.

19. The apparatus of claim 12, further comprising:
means for automatically addressing non-responsive interview requests by any of resending said requests, generating alerts, escalation, or combinations thereof.

20. The apparatus of claim 12, said a plurality of electronic forms further comprising:
one or more templates of questions and full questionnaires, comprising any of headers and footers, embedded links, images, and other elements.

21. The apparatus of claim 12, further comprising:
one or more structural data elements and/or various widgets for authoring questions to define valid answers, define the form of answers, encapsulate an existing database or data entry fields for presentation in a virtual interview, define behaviors and actions required on occurrence of any given answer to any given question to issue an alert, initiate or complete an action item, add an entry to a database or update a database, and any combination of the foregoing.

22. The apparatus of claim 2, wherein said one or more templates are pre-authorized or approved with specific questions and/or for individual interviews prior to their use and/or publication.

23. The apparatus of claim 12, wherein interview responses are complied and/or collated according to recipient or responder, questions, answers, group or sub-group, and combinations thereof.
